(19) United States
(12) Patent Application Publication
(10) Pub. No.: US 2001/0005199 A1
(43) Pub. Date: Jun. 28, 2001

(54) INTERNET COMPUTER KEYBOARD

(76) Inventor: GLEN J. ANDERSON, SIOUX CITY, IA (US)

Correspondence Address: SCHWEGMAN LUNDBERG WOESSNER & KLUTH, P O BOX 2938, MINNEAPOLIS, MN, 55402

(21) Appl. No.: 08/902,811

(22) Filed: Jul. 30, 1997

(51) Int. Cl. G09G 5/00

(52) U.S. Cl. 345/168

(57) ABSTRACT

A computer keyboard having a plurality of Internet keys corresponding to at least a subset of an Internet-related software command set is disclosed. In one embodiment, the plurality of Internet keys includes a back key, a forward key, an open location key, a stop load key, a site list key, an add site key, a reload key, a find key, and a print key. The Internet keys provide keyboard-actuated activation of Internet-related software such as Netscape Navigator and Microsoft Internet Explorer without the need for hot keys or the remapping of function or DOS keys.

### FIELD OF THE INVENTION

The present invention relates generally to computer keyboards, and more specifically to such keyboards that have keys specifically defined for Internet-related software.

### BACKGROUND OF THE INVENTION

Internet communications have become an increasingly significant application for personal computers. Computer software such as Netscape Navigator and Microsoft Internet Explorer enable computer users to explore the Internet, including the worldwide web (WWW). To provide for full-featured Internet access, the software usually have rich command sets, accessibility to each command of which is provided for in at least two or three different ways.

First, Internet-related software usually defines a keyboard shortcut, or “hot key,” for each command. In Netscape Navigator, for example, holding down the control and alt keys while pressing the cursor left arrow key commands the browser to move back to the previously viewed web page. Keyboard shortcuts are convenient, in that the user's hands remain on the keyboard while initiating a command. There are usually very many commands, however, and memorization of a larger number of arcane and easily forgotten keystroke combinations is thus required to effectively use this feature.

Second, Internet-related software usually display a row of labeled “buttons” on the screen that are each linked to a command. In Netscape Navigator, for example, using a pointing device to press the “reload” button reloads the currently displayed web page. Buttons, however, deplete valuable screen real estate, which is better used for the display of web pages. Furthermore, buttons require the user to move a hand from the keyboard to the pointing device, which can be inconvenient and time consuming.

Finally, Internet-related software usually display a series of pull-down menus at the top of the screen to provide command accessibility. In Netscape Navigator, for example, using the pointing device to select the Open Location menu item within the File Menu permits the opening of any user-desired web page located at a URL. This is also, however, a pointing device-intensive and therefore time-consuming task.

The closest but nevertheless inapplicable prior art is the LaunchBoard, which is a keyboard sold and believed to be manufactured by Darwin Keyboards of San Francisco, Calif. The LaunchBoard is a customizable keyboard that remaps the function keys and the DOS keys print screen, scroll lock, and break, to user-defined web sites and applications. The LaunchBoard, however, has significant shortcomings.

First, the LaunchBoard does not provide specific keys for the command sets of Internet-related software. The user cannot use the LaunchBoard to initiate a command, such as “move back to the previously viewed web page,” “reload the currently viewed web page,” and “open a user-desired web page at a URL,” as have been described. The LaunchBoard only permits the user to start or select software, and then to access previously mapped web sites.

Second, the LaunchBoard does not provide additional keys dedicated to Internet-related software. It only remaps the currently existing function and DOS keys of the keyboard. Once remapped, these keys cannot concurrently be used for other purposes, even though other non Internet-related software may use them. Furthermore, the keys are haphazardly located as a row of keys on the keyboard, and not as a logical grouping of keys conducive to easy and intuitive use.

### SUMMARY OF THE INVENTION

The above-mentioned shortcomings are addressed by the present invention, which will be understood by reading and studying the following specification. The invention describes a computer keyboard that has a plurality of Internet keys corresponding to at least a subset of an Internet-related software command set. The keys are preferably organized in a grid having at least two rows and at least two columns of keys, each key labeled with a corresponding command.

The inventive keyboard therefore provides advantageous accessibility to the commands of Internet-related software such as Netscape Navigator or Microsoft Internet Explorer. The commands are initiated without the use of a pointing device. The user does not have to memorize a daunting list of keystroke combinations (such as “CTRLALT-left arrow”). The inventive keyboard does not remap the function and DOS keys, which remain available for use by other software.

In different embodiments of the invention, computer keyboards and computerized systems of varying scope are described. Still other and further aspects, advantages and embodiments of the invention will become apparent by reference to the drawings and by reading the following detailed description.

### BRIEF DESCRIPTION OF THE DRAWINGS

FIG. 1 is a diagram of a computerized system according to one embodiment of the invention;

FIG. 2(a) is a diagram showing in more detail the inventive keyboard of FIG. 1;

FIG. 2(b) is a diagram showing more specifically the Internet-related keys of the keyboard of FIG. 2(a); and,

FIG. 3 is a screen shot of a typical Internet-related software, Netscape Navigator.

### DETAILED DESCRIPTION OF THE INVENTION

In the following detailed description of the preferred embodiments, reference is made to the accompanying drawings which form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the appended claims.

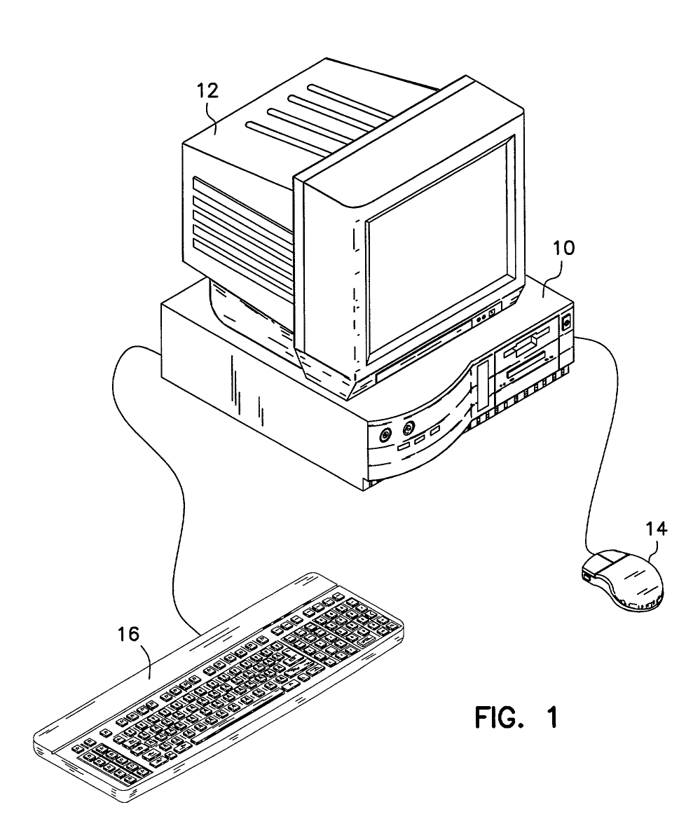

Referring first to FIG. 1, a diagram of a computerized system according to one embodiment of the invention is shown. Computer 10 is coupled to monitor 12, pointing device 14, and inventive keyboard 16. Computer 10 includes a processor (preferably, an Intel Pentium processor), random-access memory (RAM) (preferably, at least sixteen megabytes), read-only memory (ROM), and one or more storage devices, such as a hard disk drive, a floppy disk drive, an optical disk drive, and a tape cartridge drive. The invention is not particularly limited to any type of computer 10. Computer 10 preferably is a PC-compatible computer running a version of the Microsoft Windows operating system. The construction and operation of such computers are well known within the art.

Computer 10 is communicatively connected to the Internet, any particular manner by which the invention is not limited to, and which is not shown in FIG. 1. Internet connectivity is well known within the art. In one embodiment, the computer includes a modem and corresponding communication drivers to connect to the Internet via what is known in the art as a “dial-up connection.” In another embodiment, the computer includes an Ethernet or similar hardware card to connect to a local-area network (LAN) that itself is connected to the Internet via what is know in the art as a “direct connection” (e.g., T1 line, etc.).

Computer 10 also has at least one Internet-related software running thereon to utilize the Internet connectivity. Such software preferably includes at least one of Netscape Navigator and Microsoft Internet Explorer, both of which provide access to the Internet's world-wide web (WWW), Usenet newsgroups, and electronic mail features. The invention is not limited to any particular Internet-related software, however.

Computer 10 preferably includes a keyboard driver for the inventive keyboard. A keyboard driver is a computer program residing in software, hardware, or a combination of software and hardware that provides for the configuration of a keyboard in conjunction with the operating system running on the computer. The driver specifies how to interpret signals received from the computer keyboard. The design and development of keyboard drivers for operating systems such as versions of Microsoft Windows is well known within the art. Preferably, the keyboard driver of computer 10 automatically detects installed Internet-related software and correspondingly maps the Internet keys. Alternatively, the driver also permits a user to manually select Internet-related software and configure the mapping of Internet keys to Internet-related software commands.

Monitor 12 permits the display of information for viewing by a user of the computer. The invention is not limited to any particular monitor 12. Such monitors include cathode ray tube (CRT) displays, as well as flat panel displays such as liquid crystal displays (LCD's). Pointing device 14 permits the control of the screen pointer provided by the graphical user interface of operating systems such as versions of Microsoft Windows. The invention is not limited to any particular pointing device 14. Such pointing devices include mouses, touch pads, trackballs, and point sticks. In one embodiment, computer 10 is a Gateway desktop personal computer, monitor 12 includes a super-VGA CRT display, and pointing device 14 is a mouse.

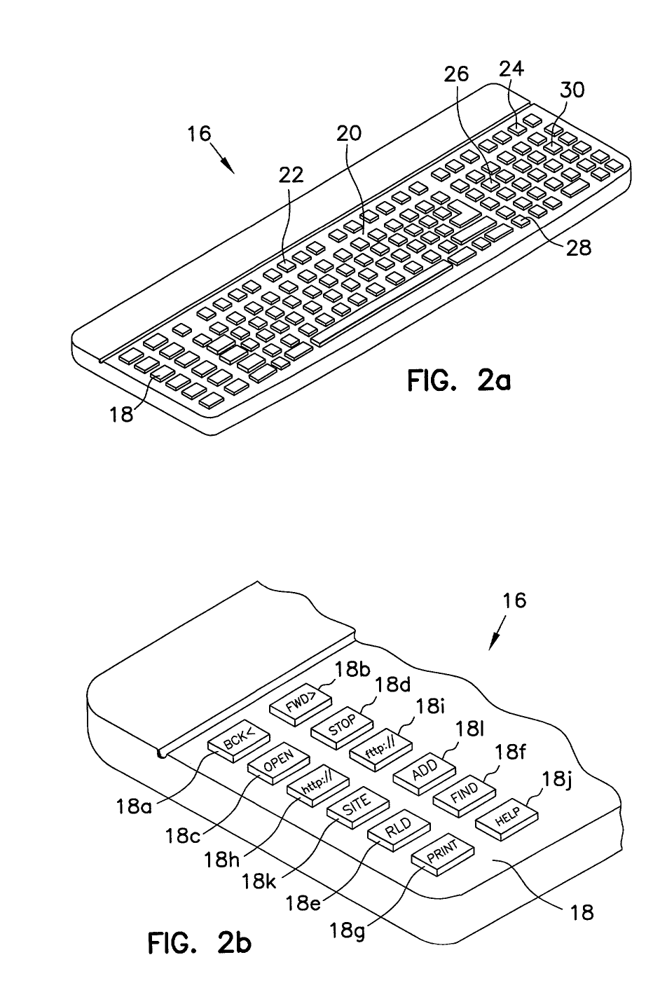

Referring now to FIG. 2(a), a diagram showing in more detail the inventive keyboard of FIG. 1 is shown. Inventive keyboard 16 includes Internet keys corresponding to at least a subset of the commands for Internet-related software. Internet keys 18 of keyboard 16 are preferably organized in a grid of two columns and six rows of keys. That is, keys 18 are organized such that they are grouped together functionally for easy and convenient accessibility. Besides the addition of Internet keys 18, keyboard 16 as shown in FIG. 2(a) is identical to a standard computer keyboard. That is, keyboard 16 includes primary typing keys 20 (the alphabetical keys of which are organized in typical QWERTY fashion), function keys 22 (including function keys F1 through F12), DOS keys 24 (including print screen, scroll lock, and break keys), navigation keys 26 (including insert, delete, home, end, page up, and page down keys), cursor keys 28, and numeric keypad keys 30. The invention is not particularly limited to any keyboard configuration, however.

Actuation of any of Internet keys 18 while an Internet-related software is running and is the active application on the computer causes the Internet-related software to perform the command associated with the actuated key. Preferably, at least most of the Internet keys correspond to commands for more than one Internet-related software (e.g., Microsoft Internet Explore in addition to Netscape Navigator). The invention is not so limited, however. Each of Internet keys 18 is also preferably labeled with the command with which it is associated.

The commands to which keys 18 correspond are in the absence of the inventive keyboard performed by the Internet-related software in response to the entry of a keystroke combination, the pressing of a button on the screen, or the selection of a menu item from a pull-down menu on the screen, as has been described. The invention is unique, therefore, in that it provides for performance of a command in response to the actuation of only a single key on the keyboard. In other embodiments of the invention, Internet-related software commands also correspond to keystroke combinations including one of Internet keys 18 (e.g., one of Internet keys 18 along with SHIFT, CTRL, ALT, etc.).

The invention is not limited to any particular subset of any particular Internet-related software command set for which Internet keys are provided on the keyboard. Any Internet-related software command is amenable to the invention. A particular Internet key 18 may not correspond to exactly the same command across different Internet-related software. For example, an Internet help key may cause Netscape Navigator to display a help menu, while causing Microsoft Internet Explorer to display a help file.

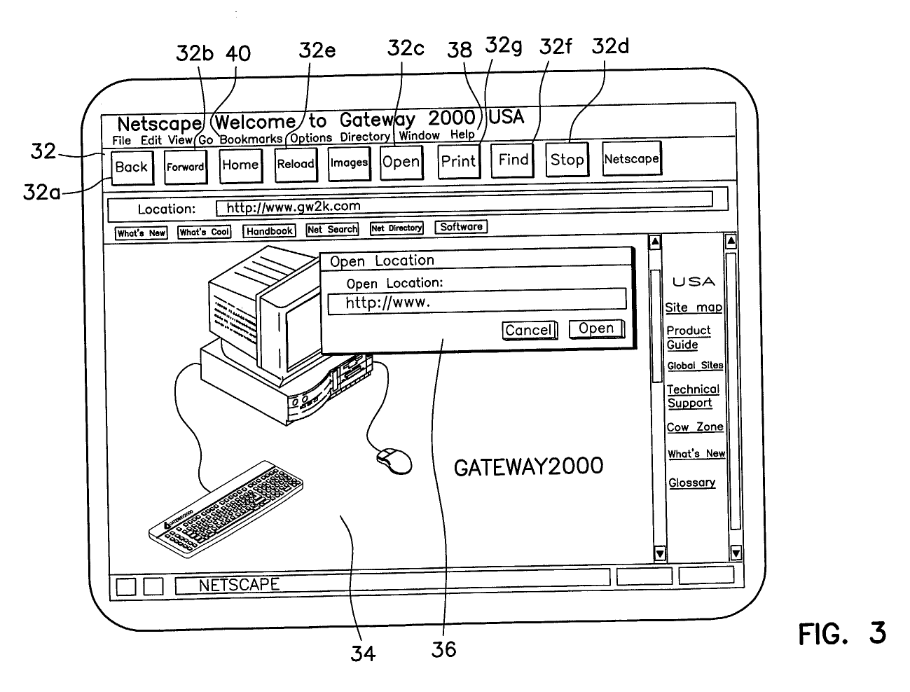

In a preferred embodiment, the inventive keyboard has Internet keys 18 as specifically shown in FIG. 2(b). The function of each of Internet keys 18 is described for illustrative purposes only in conjunction with the screen shot of Netscape Navigator shown in FIG. 3. The preferred Internet keys 18 are also functional in conjunction with other Internet-related software, such as Microsoft Internet Explorer. Referring now to FIG. 2(b), actuating back key 18a or forward key 18b corresponds to and activates the command otherwise associated with the pressing of back screen button 32a or forward screen button 32b, respectively, of screen buttons 32 as shown in the screen shot of FIG. 3. Similarly, actuating open location key 18c, stop load key 18d, reload key 18e, find key 18f, or print key 18g corresponds to and activates the command otherwise associated with the pressing of open location screen button 32c, stop load screen button 32d, reload screen button 32e, find screen button 32f, or print screen button 32g, respectively, of screen buttons 32 as shown in the screen shot of FIG. 3.

Still referring to FIG. 2(b), actuating “http://www.” key 18h or “fttp://www.” key 18i corresponds to and causes sequential text entry of the characters of the textual string “http://www.” or “fttp://www.”, respectively, within an active text-entry area on the screen. For example, referring to FIG. 3, pressing open location screen button 32c causes the display of open location dialog box 34, which includes text-entry area 36. Actuating “http://www.” key 18h after box 34 has been opened causes the sequential text entry of the characters of the textual string “http://www.” within text-entry area 36, as if the user of the computer had typed the string on the keyboard.

Referring back to FIG. 2(b), actuating help key 28j corresponds to and causes the selection of help menu 38 as shown in the screen shot of FIG. 3. Selecting help menu 38 causes the menu to what is known in the art as “drop down,” which displays the menu items of that menu on the screen. Actuating site list key 18k corresponds to and causes the activation of the “Go to Bookmarks . . . ” command of Netscape Navigator otherwise initiated via the keystroke combination “CTRL-B” or via the “go to Bookmarks . . . ” menu item of bookmarks menu 40 as shown in the screen shot of FIG. 3. Finally, actuating add site key 181 corresponds to and causes the activation of the “Add Bookmark” command of Netscape Navigator otherwise initiated via the keystroke combination “CTRL-D” or via the “Add Bookmarks” menu item within bookmarks menu 40 as shown in the screen shot of FIG. 3.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention. For example, the invention has been shown preferably in relation to the Internet-related software Netscape Navigator. However, the invention is amenable to any Internet-related software. Therefore, it is manifestly intended that this invention be limited only by the following claims and equivalents thereof.

I claim:

1. A computer keyboard comprising:
a housing;
a plurality of alphanumeric keys disposed within the housing;
a plurality of function keys disposed within the housing; a plurality of Internet keys disposed within the housing and corresponding to at least a subset of an Internet-related software command set.

2. The computer keyboard of claim 1, further comprising a plurality of DOS keys, a plurality of navigation keys, and plurality of cursor control keys, and a plurality of numeric keypad keys, all disposed within the housing.

3. The computer keyboard of claim 1, wherein the Internet keys are organized in a grid of at least two columns of keys and at least two rows of keys.

4. The computer keyboard of claim 1, wherein the plurality of Internet keys includes a key for each of a plurality of commands for at least one Internet-related software selected from the group of Internet-related software consisting of Netscape Navigator and Microsoft Internet Explorer.

5. The computer keyboard of claim 1, wherein the plurality of Internet keys includes at least one key from the group consisting of a back key, a forward key, an open location key, a stop load key, a site list key, an add site key, a reload key, a find key, and a print key.

6. A computerized system comprising:
a computer having at least a processor and a memory; and,
a keyboard operatively coupled to the computer and having a plurality of Internet keys corresponding to at least a subset of an Internet-related software command set.

7. The computerized system of claim 6, wherein the Internet keys are organized in a grid of at least two columns of keys and at least two rows of keys.

8. The computerized system of claim 6, wherein the plurality of Internet keys includes a key for each of a plurality of commands for at least one Internet-related software selected from the group of Internet-related software consisting of Netscape Navigator and Microsoft Internet Explorer.

9. The computerized system of claim 6, wherein the plurality of Internet keys includes at least one key from the group consisting of a back key, a forward key, an open location key, a stop load key, a reload key, a find key, and a print key.
